(19) United States
(12) Patent Application Publication
(10) Pub. No.: US 2025/0092558 A1
(43) Pub. Date: Mar. 20, 2025

(54) Metal Oxyhydroxide Nanoparticle for Lithium Ion Batteries and Production Method Thereof

(71) Applicant: Korea Advanced Institute of Science and Technology, Daejeon (KR)

(72) Inventors: Sung Oh CHO, Daejeon (KR); Jaewoo LEE, Daejeon (KR)

(73) Assignee: Korea Advanced Institute of Science and Technology, Daejeon (KR)

(21) Appl. No.: 18/733,561

(22) Filed: Jun. 4, 2024

(30) Foreign Application Priority Data
Sep. 14, 2023 (KR) 10-2023-0122455

(51) Int. Cl. C25D 11/34; C25D 17/12

(52) U.S. Cl. CPC C25D 11/34; C25D 17/12

(57) ABSTRACT

Disclosed herein are an amorphous metal oxyhydroxide represented by Chemical Formula 1 below, a negative electrode active material for a secondary battery including the same, and a method for producing the same.

MₓO_{y}(OH)_{z} [Chemical Formula 1]

In [Chemical Formula 1] above, M is one or more selected from the group consisting of tin, aluminum, titanium, vanadium, chromium, manganese, iron, cobalt, nickel, gallium, zirconium, niobium, molybdenum, indium, and tantalum, and 0.4≤x≤0.7, 0.1≤y≤0.4, 1.6≤z≤1.9, y+z=2, and −0.1≤4x-2y-z≤0.1.

### CROSS-REFERENCES TO RELATED APPLICATION

This patent application claims the benefit of priority from Korean Patent Application No. 10-2023-0122455, filed on Sep. 14, 2023, the contents of which are incorporated herein by reference.

### BACKGROUND OF THE INVENTION

### 1. Field of the Invention

The present disclosure relates to a method for producing a negative electrode material for lithium ion batteries by using metal oxyhydroxide nanoparticles.

### 2. Description of the Related Art

In recent years, the development of various power storage devices such as lithium ion batteries has been actively conducted. Particularly, the demand for high-output, high-energy density lithium ion secondary batteries is rapidly expanding along with the development of the semiconductor industry such as portable information terminals and mobile phones, smartphones, tablets, or laptop computers, portable music players, digital cameras, medical devices, next-generation clean energy vehicles (hybrid electric vehicles (HEV), electric vehicles (EV), plug-in hybrid electric vehicles (PHEV), etc.), and the lithium ion secondary batteries have become indispensable in the modern information society as a source of rechargeable energy. [Korean Patent Laid-open Publication No. 10-2021-0143215]

The battery capacity and cycle life of a lithium ion secondary battery depend on the negative electrode material thereof. Currently, graphite is mainly used as a negative electrode active material in a negative electrode material, and is suitable as a negative electrode active material due to the structural stability thereof, but has a fatal disadvantage of having a low theoretical battery capacity (372 mAh/g).

Recently, research has been conducted that various metal oxides which have a higher battery capacity than graphite may be used as negative electrode active materials, but there are limitations in commercializing the metal oxides as negative electrode active materials due to insufficient cycle stability caused by a significant volume change and a low ionic and electrical conductivity during charging and discharging processes.

Therefore, in order to increase the capacity of a lithium ion secondary battery, there has been a demand for the development of a new material which is capable of reducing the change in volume during charging and discharging as the negative electrode material thereof, and which has a higher battery capacity than graphite while having higher ionic and electrical conductivity than the same.

### SUMMARY OF THE INVENTION

An object of the present invention is as follows.

In one aspect, there is provided an amorphous metal oxyhydroxide.

In one aspect, there is provided a negative electrode active material for a secondary battery, the negative electrode active material containing the metal oxyhydroxide.

In one aspect, there is provided a negative electrode material for a secondary battery, the negative electrode material containing the metal oxyhydroxide.

In one aspect, there is provided a secondary battery containing the metal oxyhydroxide.

In one aspect, there is provided a method for producing a metal oxyhydroxide, the method for producing the metal oxyhydroxide.

In one aspect, there is provided an amorphous metal oxyhydroxide produced by the method for producing a metal oxyhydroxide.

In one aspect, the present invention provides an amorphous metal oxyhydroxide represented by Chemical Formula 1 below.

MₓO_{y}(OH)_{z} [Chemical Formula 1]

In [Chemical Formula 1] above, M is one or more selected from the group consisting of tin, aluminum, titanium, vanadium, chromium, manganese, iron, cobalt, nickel, gallium, zirconium, niobium, molybdenum, indium, and tantalum, and 0.4≤x≤0.7, 0.1≤y≤0.4, 1.6≤z≤1.9, y+z=2, and −0.154x-2y-z≤0.1.

In another aspect, the present invention provides a negative electrode active material for a secondary battery, the negative electrode active material containing the metal oxyhydroxide.

In another aspect, the present invention provides a negative electrode material for a secondary battery, the negative electrode material containing the metal oxyhydroxide.

In another aspect, the present invention provides a secondary battery containing the metal oxyhydroxide.

In another aspect, the present invention provides a method for producing a metal oxyhydroxide, the method for producing the metal oxyhydroxide.

In another aspect, the present invention provides a metal oxyhydroxide produced by the method for producing a metal oxyhydroxide.

### BRIEF DESCRIPTION OF THE DRAWINGS

FIG. 1 is a schematic diagram illustrating a process of synthesizing tin oxide-based nanoparticles according to the present invention by using an electrochemical anodization method.

FIG. 2 is a digital photograph of tin oxyhydroxide nanoparticles according to the present invention.

FIG. 3 shows a transmission electron microscope (TEM) image of a-SnOOH nanoparticles synthesized in a 1 mol/L KI aqueous solution.

FIG. 4 is a graph showing a size distribution of a-SnOOH nanoparticles synthesized in a 1 mol/L KI aqueous solution.

FIG. 5 shows the result of X-ray diffraction (XRD) analysis of various tin oxide-based nanoparticles synthesized in various potassium halide aqueous solutions.

FIG. 6 shows the result of Fourier-transform infrared (FT-IR) spectrum analysis before and after performing heat treatment on a-SnOOH nanoparticles synthesized in a 1 mol/L KI aqueous solution.

FIG. 7 shows the result of O 1s X-ray photoelectron spectroscopy (XPS) spectrum analysis of a-SnOOH nanoparticles synthesized in a 1 mol/L KI aqueous solution.

FIG. 8 shows the result of electron spin resonance (ESR) spectroscopy spectrum analysis of a-SnOOH nanoparticles synthesized in a 1 mol/L KI aqueous solution with or without glycerol.

FIG. 9 shows a TEM image of a-SnOOHNO nanoparticles synthesized in a 1 mol/L KI aqueous solution containing glycerol.

FIG. 10 shows a size distribution of a-SnOOHNO nanoparticles synthesized in a 1 mol/L KI aqueous solution containing glycerol.

FIG. 11 shows the result of FT-IR spectrum analysis of a-SnOOH nanoparticles and a-SnOOHNO nanoparticles.

FIG. 12 shows the result of O 1s XPS spectrum analysis of a-SnOOHNO nanoparticles.

FIG. 13 shows a high-resolution TEM (HRTEM) image and the result of selected-area electron diffraction (SAED) pattern (scale bar=5/nm) of a-SnOOH nanoparticles.

FIG. 14 shows the result of energy-dispersive X-ray spectroscopy (EDS) mapping (scale bar=30 nm) of a-SnOOH nanoparticles.

FIG. 15 shows an HRTEM image and the result of SAED pattern (scale bar=5/nm) of a-SnOOHNO nanoparticles.

FIG. 16 shows the result of EDS mapping (scale bar=50 nm) of a-SnOOHVO nanoparticles.

FIG. 17 shows results of cycle performance of negative electrodes of a-SnOOH nanoparticles, a-SnOOHNO nanoparticles, and a c-SnOOH nanoparticles at a current rate of 0.2 C.

FIG. 18 shows a cyclic voltammetry (CV) curve of a a-SnOOHNO nanoparticle negative electrode.

FIG. 19 shows charge/discharge potential curves of a a-SnOOHNO nanoparticle negative electrode at a current rate of 0.2 C.

FIG. 20 shows rate properties of a a-SnOOHNO nanoparticle negative electrode.

FIG. 21 shows Nyquist plots of negative electrodes of a-SnOOH nanoparticles, a-SnOOHNO nanoparticles, and c-SnOOH nanoparticles after the first cycle at a current rate of 0.1 C.

FIG. 22 is an enlarged view of a high-frequency region of the curves of FIG. 21.

FIG. 23 shows the relationship between Z′ and ω^{-1/2} in a low-frequency region of the Nyquist plots of FIG. 21.

FIG. 24 shows enlarged spectra and straight line fitting results in an ion-diffusion region of the curves of FIG. 23.

FIG. 25 shows cycle performance of negative electrodes of a-SnOOH nanoparticles, a-SnOOHNO nanoparticles, and c-SnOOH nanoparticles at a current rate of 2 C.

FIG. 26 shows charge/discharge potential curves of a a-SnOOHNO nanoparticle negative electrode at a current rate of 2 C.

FIG. 27 shows long-term cycle performance of a a-SnOOHNO nanoparticle negative electrode at a current rate of 0.2 C.

FIG. 28 shows a field emission scanning electron microscope (FESEM) image of the surface of a-SnOOHNO nanoparticle negative electrode before a cycle test.

FIG. 29 shows an FESEM image of the surface of a-SnOOHNO nanoparticle negative electrode after a cycle test.

FIG. 30 shows the result of XRD pattern of c-SnO₂ nanoparticles produced by the production method of the present application.

FIG. 31 shows the result of TEM of c-SnO₂ nanoparticles produced by the production method of the present application.

FIG. 32 shows cycle performance of negative electrodes of c-SnO₂ nanoparticles and c-SnOOH nanoparticles produced by the production method of the present application.

FIG. 33 shows Nyquist plots of negative electrodes of c-SnO₂ nanoparticles and c-SnOOH nanoparticles after the first cycle at a current rate of 0.1 C.

FIG. 34 is an enlarged view of a high-frequency region of the curves of FIG. 33.

FIG. 35 shows the relationship between Z′ and ω^{-1/2} in a low-frequency region of the Nyquist plots of FIG. 33.

FIG. 36 shows enlarged spectra and straight line fitting results in an ion-diffusion region of the curves of FIG. 35.

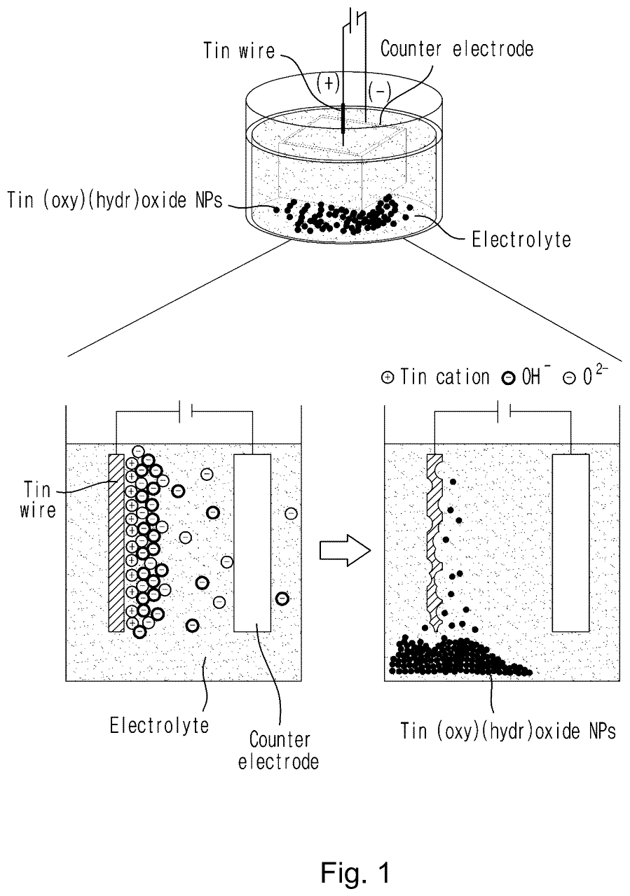

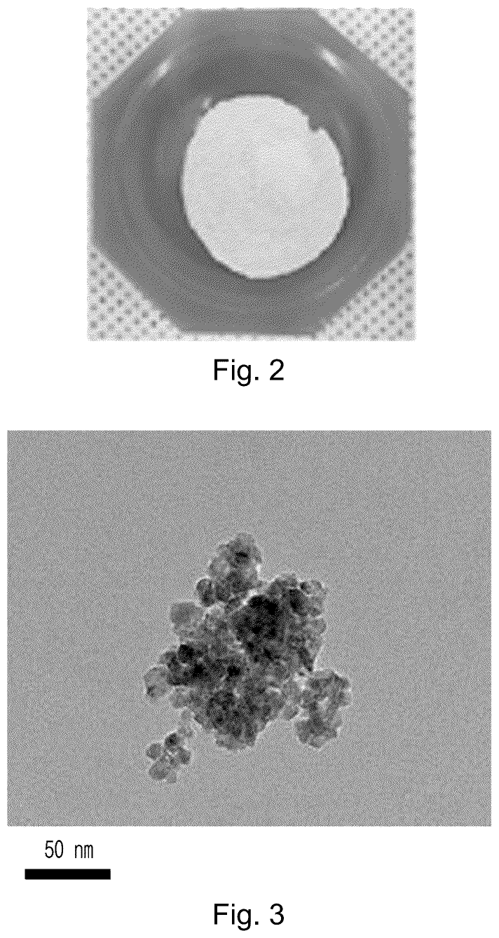

### DESCRIPTION OF THE INVENTION

Hereinafter, the present invention will be described in detail.

Meanwhile, embodiments of the present invention may be modified into various other forms, and the scope of the present invention is not limited to the embodiments described below. In addition, the embodiments of the present invention are provided in order to more fully describe the present disclosure to those with average knowledge in the art.

Furthermore, when a certain component is “included,” it means that, unless specifically stated otherwise, other components may be further included, rather than excluding other components.

In the present specification, “a-” refers to an amorphous state, “c-” refers to a crystalline state, and “NP(s)” refers to nanoparticle(s).

In the present specification and a chemical formula according to the same, “M” refers to a metal, and “MOOH” collectively refers to a structure having an oxyhydroxide form of a metal, such as a compound represented by Chemical Formula 2 below, and is not restricted to the chemical formula. For example, a compound represented by “SnOOH” collectively refers to an oxyhydroxide form of tin, and includes all oxyhydroxide forms of tin represented by Chemical Formula 3 below, and the chemical formula thereof is not limited to SnOOH, or the chemical formula of a general divalent tin oxyhydroxide is not limited to Sn₆O₄(OH)₄.

MₓO_{y}(OH)_{z} [Chemical Formula 2]

In Formula 2 above, x, y, and z are greater than 0.

SnₓO_{y}(OH)_{z} [Chemical Formula 3]

In Formula 3 above, x, y, and z are greater than 0.

In the present specification, “SnO₂ nanoparticles” or “SnO₂ NP(s)” refer to tin oxide nanoparticles, and the nanoparticles are represented by the chemical formula SnO₂.

In the present specification, “oxygen vacancy (VO(s))” refers to a state in which particles lack oxygen, and this state refers to a state in which there is a defect.

For example, in the present specification, “a-SnOOH nanoparticles” or “a-SnOOH NP(s)” refer to amorphous tin oxyhydroxide nanoparticles. In addition, for example, “a-SnOOHNO nanoparticles” or “a-SnOOHNO NP(s)” refer to defective amorphous tin oxyhydroxide nanoparticles. In addition, for example, “c-SnOOH nanoparticles” or “c-SnOOH NP(s)” refer to crystalline tin oxyhydroxide nanoparticles. In addition, for example, “c-SnO₂ nanoparticles” or “c-SnO₂ NP(s)” refer to crystalline tin oxide nanoparticles.

An amorphous metal oxyhydroxide provided in the present invention is represented by Chemical Formula 1 below.

MₓO_{y}(OH)_{z} [Chemical Formula 1]

In [Chemical Formula 1] above, M is one or more selected from the group consisting of tin, aluminum, titanium, vanadium, chromium, manganese, iron, cobalt, nickel, gallium, zirconium, niobium, molybdenum, indium, and tantalum, and 0.4≤x≤0.7, 0.1≤y≤0.4, 1.6≤z≤1.9, y+z=2, and −0.154x-2y-z≤0.1.

In x of [Chemical Formula 1] above, 0.4≤x≤0.7, preferably 0.5≤x≤0.6. In y, it is 0.1≤y≤0.4, preferably 0.2≤y≤0.3. In z, it is 1.6≤z≤1.9, preferably 1.7≤z≤1.8.

In an embodiment, in [Chemical Formula 1] above, M may be tin. Among metals, tin has advantages of being easily obtainable naturally, environmentally friendly, and low in price in addition to having a high theoretical capacity.

The amorphous metal oxyhydroxide provided in the present invention may be in the form of nanoparticles. In the present specification, “nanoparticles” refer to particles having a diameter of 100 nm or less. In an embodiment, the amorphous metal oxyhydroxide provided in the present invention may have a diameter of 2 nm to 9 nm, 2.5 nm to 8.5 nm, and 3 nm to 8 nm, and the average diameter thereof may be 4 nm to 7 nm, 4.5 nm to 6.5 nm, and 5 nm to 6 nm.

The amorphous metal oxyhydroxide provided in the present invention may be in a VO state, that is, “a state in which particles lack oxygen.” A compound in the VO state is a compound represented by the corresponding chemical formula as a result of XRD analysis, but refers to a compound in a state of having a spin density Ns (spin/g) of 1.00×10¹⁰ or higher.

The amorphous metal oxyhydroxide in the VO state provided in the present invention may have a spin density of 1.00×10¹⁰ or higher, 1.00×10¹⁰ to 1.00×10³, or 1.00×10¹⁵ to 1.00×10²⁵. In an embodiment, the amorphous metal oxyhydroxide in the VO state provided in the present invention may have a spin density of 2.00×10¹⁶ to 2.00×10²², or 2.00×10¹⁷ to 2.00×10²¹.

The amorphous metal oxyhydroxide in the VO state provided in the present invention may have a diameter of 0.1 nm to 8 nm, 0.5 nm to 7.5 nm, or 1 nm to 7 nm, and may have an average diameter of 2.5 nm to 5.5 nm, 3 nm to 5 nm, or 3.5 nm to 4.5 nm.

A negative electrode active material for a secondary battery provided in the present invention includes the above-described amorphous metal oxyhydroxide represented by [Chemical Formula 1].

A negative electrode material for a secondary battery provided in the present invention includes the above-described amorphous metal oxyhydroxide represented by [Chemical Formula 1]. In an embodiment, the negative electrode material according to the present invention may include the above-described negative electrode active material for a secondary battery.

A secondary battery provided in the present invention includes the above-described amorphous metal oxyhydroxide represented by [Chemical Formula 1]. In an embodiment, the secondary battery according to the present invention may include the above-described negative electrode material for a secondary battery.

A method for producing an amorphous metal oxyhydroxide provided in the present invention includes the step of obtaining the above-described amorphous metal oxyhydroxide represented by [Chemical Formula 1] through an anodization process through a 2-electrode electrochemical system including a working electrode including one or more selected from the group consisting of tin, aluminum, titanium, vanadium, chromium, manganese, iron, cobalt, nickel, gallium, zirconium, niobium, molybdenum, indium, and tantalum, a counter electrode, and an electrolyte containing a potassium halide aqueous solution.

The description of [Chemical Formula 1] is the same as described above.

The amorphous metal oxyhydroxide may be obtained in the form of nanoparticles, and the spin density thereof and the diameter of the particles are the same as described above.

In the metal oxyhydroxide of the present invention or the production method thereof, the potassium halide aqueous solution may one or more selected from the group consisting of a KF aqueous solution, a KCl aqueous solution, a KBr aqueous solution, and a KI aqueous solution. In an embodiment, the potassium halide aqueous solution is a KI aqueous solution. In an embodiment, only the KI aqueous solution may be used as the potassium halide aqueous solution, but glycerol may be additionally used in addition to the KI aqueous solution.

In an embodiment, the working electrode contains tin. In an embodiment, the counter electrode contains stainless steel.

In an embodiment, the electrolyte may have a concentration of 0.5 mol/L to 2 mol/L, preferably 0.6 mol/L to 1.5 mol/L, or 0.7 mol/L to 1.3 mol/L. In an embodiment, the electrolyte has a concentration of 0.9 mol/L to 1.1 mol/L.

In an embodiment, the 2-electrode electrochemical system may have a voltage of DC 5 to 25 V, or DC 10 to 20 V. In an embodiment, the voltage is DC 13 to 17 V.

In an embodiment, the 2-electrode electrochemical system may have anodization time of 5 minutes to 25 minutes, or 10 minutes to 20 minutes. In an embodiment, the time is 13 minutes to 17 minutes.

In an embodiment, the anodization process is performed through a stirring process.

The production method may further includes a step of filtering the obtained metal oxyhydroxide, washing the obtained metal oxyhydroxide, or drying the obtained metal oxyhydroxide.

Hereinafter, the present invention will be described with reference to examples and experimental examples, but the present invention is not limited to the examples and experimental examples presented by the present invention.

### Example 1-1

Nanoparticles were collected through an anodization process using a 2-electrode electrochemical system in which a tin wire (diameter 1.0 mm, 99.9%) was a working electrode and a stainless steel cell (20 mm×20 mm×15 mm, thickness 2 mm) was a counter electrode.

The 2-electrode electrochemical system was created by immersing both electrodes in 300 mL of KI aqueous electrolyte having a concentration of 1 mol/L. The applied voltage was set to DC 15 V, the anodization time was set to 15 minutes, and the electrolyte temperature was set to room temperature, and the anodization process was performed by magnetic stirring (100 rpm) at room temperature. The collected particles were vacuum-filtered, washed with distilled water, and then dried in an oven at about 50° C. to produce a-SnOOH nanoparticles.

### Example 1-2

a-SnOOH/VO nanoparticles were produced in the same manner as in Example 1-1, except that 300 mL of KI aqueous electrolyte having a concentration of 1 mol/L to which 100 mL of glycerol was added was used instead of 300 mL of KI aqueous electrolyte having a concentration of 1 mol/L.

### Example 2-1

An electrode was manufactured by the following process using the a-SnOOH nanoparticles (NPs) produced in Example 1-1, which were synthesized as a negative electrode active material.

Carbon black (Super P, Imerys, Paris, France) was used as a conductor and polyvinylidene fluoride was used as a binder. The a-SnOOH NPs produced in Example 1-1 were used as an active material, and the active material, the conductor, and the binder were mixed in a N-methyl-2-pyrrolidone (NMP) solvent at a weight ratio of 4:5:1.

The slurry resulting from the mixing was coated on copper foil (thickness 10 μm) at 0.5 mg/cm² using a doctor blade method. Thereafter, about 30% roll-pressing was performed at a temperature of 75° C. and a rate of 7.15 mm/s through an electric rolling mill (MSK-HRP-01, MTI Corporation, California, USA). The resultant product was vacuum-dried at 80° C. for 12 hours to manufacture a final electrode.

### Example 2-2

An electrode was manufactured in the same manner as in Example 2-1, except that the nanoparticles produced in Example 1-2 were used instead of the nanoparticles produced in Example 1-1.

### Example 3-1

To evaluate the electrochemical performance of the electrode manufactured in Example 2-1, a half-cell was manufactured using a CR2032 coin cell.

The half-cell was assembled using the CR2032 coin cell in which the electrode manufactured in Example 2-1 having a diameter of 15 mm was used as a working electrode and a lithium metal having a diameter of 16 mm and a thickness of 300 μm was used as a counter electrode. As an electrolyte solution thereof, a mixture of ethylene carbonate (EC), dimethyl carbonate (DMC), and ethyl methyl carbonate (EMC) at a volume ratio of 1:1:1 containing 1 mol/L of LiPF₆ and added with 3 wt % of fluoroethylene carbonate (FEC) was used.

### Example 3-2

A battery was manufactured in the same manner as in Example 3-1, except that the electrode manufactured Example 2-2 was used instead of the electrode manufactured in Example 2-1.

### Comparative Example 1-1

c-SnOOH nanoparticles were produced in the same manner as in Example 1-1, except that 300 mL of KCl aqueous electrolyte having a concentration of 1 mol/L was used instead of 300 mL of KI aqueous electrolyte having a concentration of 1 mol/L.

### Comparative Example 2-1

An electrode was manufactured in the same manner as in Example 2-1, except that the nanoparticles produced in Comparative Example 1-1 were used instead of the nanoparticles produced in Example 1-1.

### Comparative Example 3-1

A battery was manufactured in the same manner as in Example 3-1, except that the electrode manufactured Comparative Example 2-1 was used instead of the electrode manufactured in Example 2-1.

### Comparative Example 1-2

The resultant nanoparticles of Example 1-1 were heated in air at 500° C. for 1 hour to produce c-SnO₂ nanoparticles through a dehydration reaction.

### Comparative Example 2-2

An electrode was manufactured in the same manner as in Example 2-1, except that the nanoparticles produced in Comparative Example 1-2 were used instead of the nanoparticles produced in Example 1-1.

### Comparative Examples 3-2

A battery was manufactured in the same manner as in Example 3-1, except that the electrode manufactured Comparative Example 2-2 was used instead of the electrode manufactured in Example 2-1.

### Experimental Example 1

The particles obtained in Examples 1-1 and 1-2 and Comparative Examples 1-1 and 1-2 were analyzed through Transmission Electron Microscopy (TEM, Talos F200X, FEI Company, Oregon, USA) and High-Resolution TEM (HRTEM) to confirm the particle shape thereof.

### Experimental Example 2

The element distribution of each of the particles obtained in Examples 1-1 and 1-2 and Comparative Examples 1-1 and 1-2 was confirmed through Energy Dispersive X-ray Spectroscopy (EDS, Talos F200X, FEI Company, Oregon, USA).

### Experimental Example 3

The particles obtained in Examples 1-1 and 1-2 and Comparative Examples 1-1 and 1-2 were subjected to X-ray Diffraction (XRD, SmartLab, RIGAKU, Tokyo, Japan) using Cu Ka radiation (1.5406 nm) operated under the conditions of 45 kV and 200 mA to confirm the crystal structure thereof.

### Experimental Example 4

The particles obtained in Examples 1-1 and 1-2 and Comparative Examples 1-1 and 1-2 were subjected to Fourier-Transform Infrared spectroscopy (FT-IR, Nicolet iS50, Thermo Fisher Scientific Instrument, Massachusetts, USA) and X-ray Photoelectron Spectroscopy (XPS, K-alpha, Thermo VG Scientific, Massachusetts, USA) using Al Kα radiation (1486.7 eV) by referring to the appearance of a C 1s peak at 284.8 eV to confirm the chemical bond thereof.

### Experimental Example 5

The particles obtained in Examples 1-1 and 1-2 and Comparative Examples 1-1 and 1-2 were subjected to Thermogravimetric Analysis (TGA, STA449 F5 Jupiter, NETZSCH, Selb, Germany) under a heating rate of 10° C./min in argon.

### Experimental Example 6

The particles obtained in Examples 1-1 and 1-2 and Comparative Examples 1-1 and 1-2 were subjected to Raman analysis through a Raman/PL system (LabRAM HR Evolution Visible NIR, HORIBA, Kyoto, Japan) equipped with a 514 nm laser.

### Experimental Example 7

The particles obtained in Examples 1-1 and 1-2 and Comparative Examples 1-1 and 1-2 were subjected to Electron Spin Resonance spectroscopy (ESR, JES-FA100, JEOL, Tokyo, Japan) analysis at room temperature in a vacuum state.

### Experimental Example 8

In order to measure the BET surface area of the particles obtained in Examples 1-1 and 1-2 and Comparative Examples 1-1 and 1-2, a nitrogen adsorption method using a surface area analyzer (3Flex, Micromeritics, Georgia, USA) was performed at 77 K.

### Experimental Example 9

In order to analyze the surface of the electrodes manufactured in Examples 2-1 and 2-2 and Comparative Examples 2-1 and 2-2, Field-Emission Scanning Electron Microscopy (FESEM, Magellan400, FEI Company, Oregon, USA) analysis was performed.

### Experimental Example 10

The batteries manufactured in Examples 3-1 and 3-2 and Comparative Examples 3-1 and 3-2 were subjected to a constant current charging-discharging (galvanostatic charging-discharging) test at room temperature through an electrochemical system (WBCS3000Le32, WonATech, Seoul, Korea) under the condition of 0.005-3.0 V (vs. Li/Li⁺).

### Experimental Example 11

The batteries manufactured in Examples 3-1 and 3-2 and Comparative Examples 3-1 and 3-2 were subjected to a Cyclic Voltammetry (CV) analysis test at a scanning rate of 0.1 mV/s at room temperature through an electrochemical system (WBCS3000Le32, WonATech, Seoul, Korea).

### Experimental Example 12

The batteries manufactured in Examples 3-1 and 3-2 and Comparative Examples 3-1 and 3-2 were subjected to an Electrochemical Impedance Spectroscopy (EIS) analysis test at room temperature through a potentiostat (SP-200, BioLogic, Seyssinet-Pariset, France) with an AC amplitude of 10 mV and a frequency in the range of 100 kHz to 10 mHz.

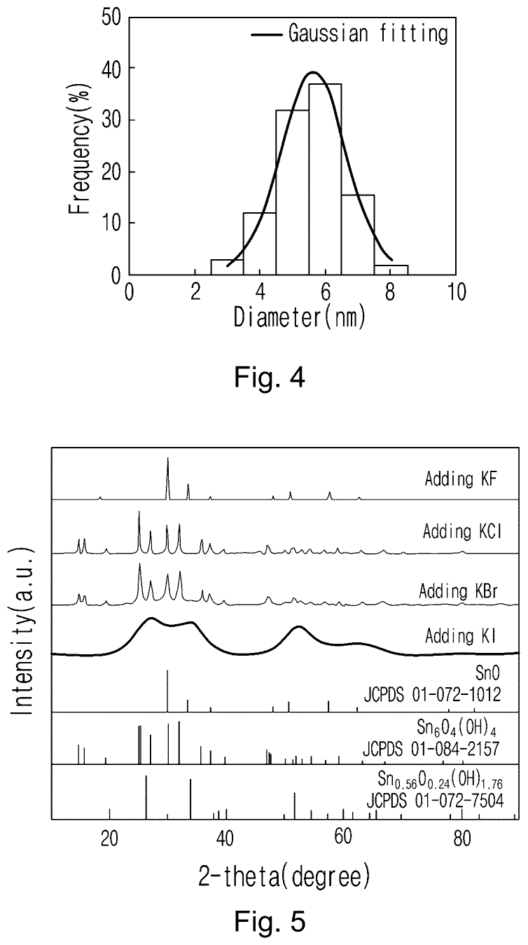

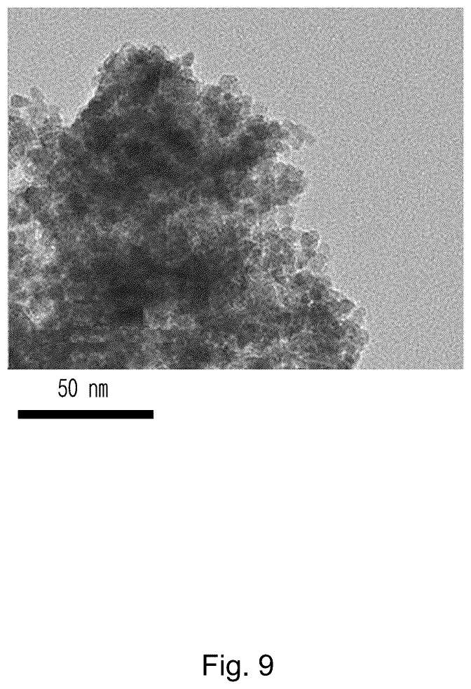

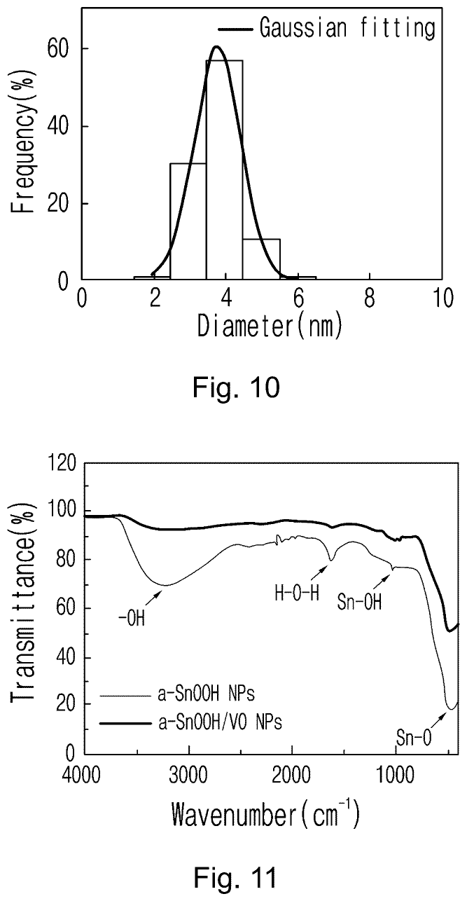

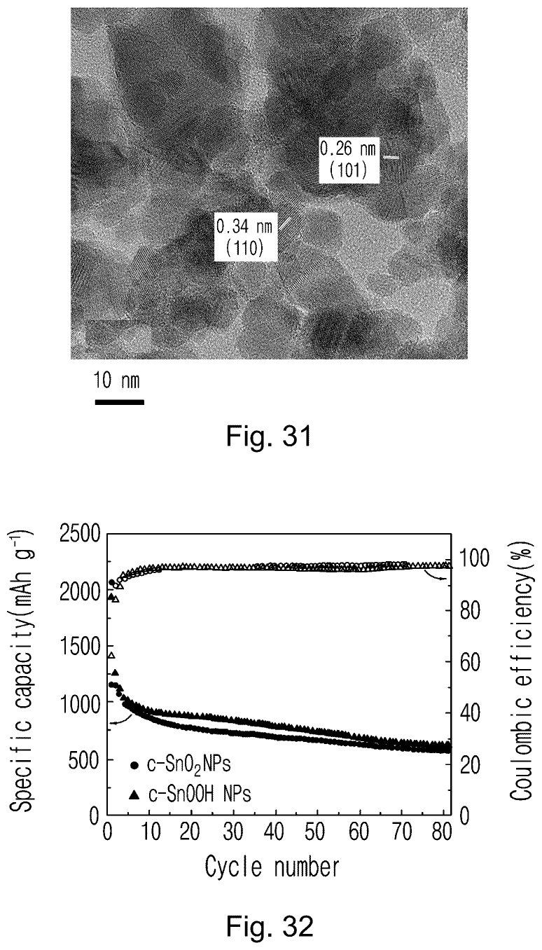

FIG. 3, FIG. 9, and FIG. 31 respectively show TEM images of the nanoparticles of Example 1-1, Example 1-2, and Comparative Example 1-2. In addition, FIG. 4 and FIG. 10 respectively show the size distribution of the nanoparticles of Example 1-1 and Example 1-2. As compared in FIG. 4 and FIG. 10, it can be seen that the diameter (size) of a-SnOOH/VO nanoparticles is smaller than that of a-SnOOH nanoparticles.

Table 1 summarizes the type of electrolytes used in the 2-electrochemical system of Examples 1-1 and 1-2 and Comparative Examples 1-1 and 1-2, whether a dehydration reaction is performed after obtaining particles, the type of particles finally obtained, and the chemical formula thereof.

TABLE 1

| | | Dehydration | | Chemical |
|---|---|---|---|---|
| | Electrolyte | reaction | Nanoparticles | Formula |
| Example 1-1 | KI | X | a-SnOOH | Sn_{0.56}O_{0.24}(OH)_{1.76} |
| Example 1-2 | KI + glycerol | X | a-SnOOH/VO | Sn_{0.56}O_{0.24}(OH)_{1.76} |
| Comparative | KCl | X | c-SnOOH | Sn₆O₄(OH)₄ |
| Example 1-1 | | | | |
| Comparative | KI | ◯ | c-SnO₂ | SnO₂ |
| Example 1-2 | | | | |

The difference between Example 1-1 and Comparative Example 1-1, that is, the difference between a-SnOOH nanoparticles and c-SnOOH nanoparticles, results from the difference in the electrolytes used in the 2-electrode electrochemical system.

FIG. 5 shows the XRD results of tin oxide-based nanoparticles according to the type of electrolyte used, and FIG. 30 shows the XRD results of Comparative Examples produced in the present application. As can be seen in FIG. 5, when KF was used as the potassium halide aqueous electrolyte, SnO nanoparticles were obtained, when KCl was used, SnOOH nanoparticles were obtained with a clear peak, when KBr was used, SnOOH nanoparticles were obtained with a wider peak than that when KCl was used, and when KI was used, SnOOH nanoparticles were obtained with an even wider peak. In the present specification, a-SnOOH nanoparticles refer to amorphous SnOOH nanoparticles, c-SnOOH nanoparticles refer to crystalline SnOOH nanoparticles, and as shown in Table 1 above, a-SnOOH nanoparticles were obtained by using a KI aqueous solution, and c-SnOOH nanoparticles were obtained by using a KCl aqueous solution.

In addition, as a result of the XRD analysis, it has been confirmed that the particles of Example 1-1, that is, a-SnOOH NPs, and the particles of Example 1-2, that is, a-SnOOHNO NPs, were close to the chemical formula Sn_{0.56}O_{0.24}(OH)_{1.76}. The particles of Comparative Example 1-1, c-SnOOH NPs, represent the chemical formula Sn₆O₄(OH)₄, which is the form of a typical tin oxyhydroxide, and the particles of Comparative Example 1-2, c-SnO₂ NPs, represent the chemical formula SnO₂, which is the form of a typical tin oxide.

The difference between Example 1-1 and Example 1-2, that is, the difference between a-SnOOH nanoparticles and a-SnOOHNO nanoparticles, results from the difference in the electrolytes used in the 2-electrode electrochemical system.

Oxygen vacancy (VO) refers to a state in which particles lack oxygen, that is, a state in which there is a defect, and the a-SnOOHNO nanoparticles of Example 1-2 were obtained by adding glycerol to the electrolyte during the production process thereof.

Glycerol has great reducing power in an aqueous solution. With the addition of glycerol in Example 1-2, the glycerol will be oxidized to become glyceraldehyde, the a-SnOOH nanoparticles will be reduced to become a-SnOOHNO nanoparticles, and the a-SnOOHNO nanoparticles will be in a state in which no oxygen or OH group is present compared to the a-SnOOH nanoparticles.

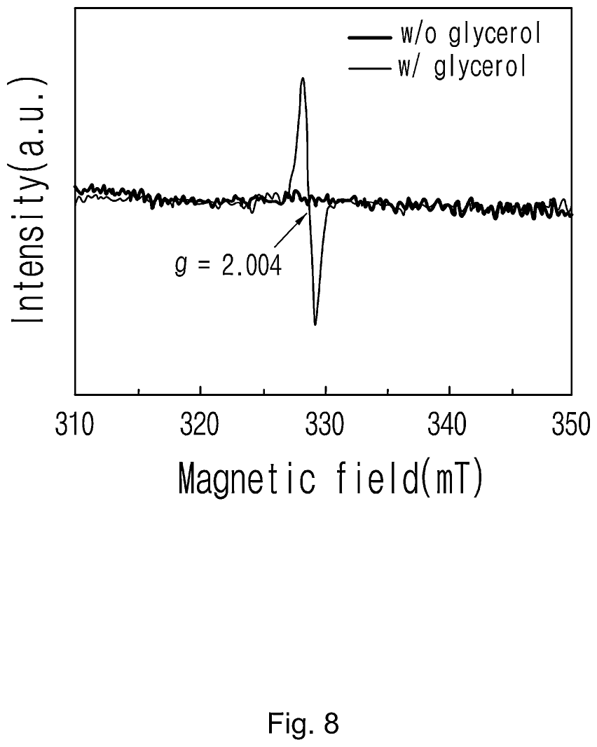

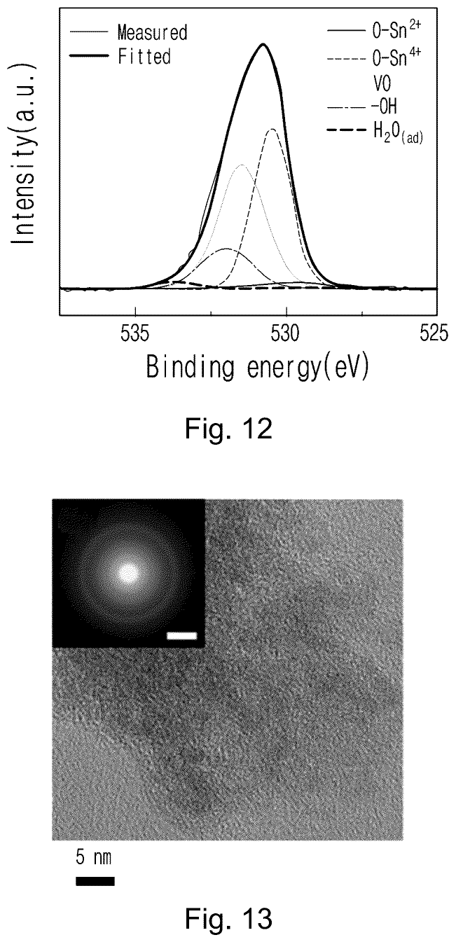

As can be seen in FIG. 7 showing the O 1s XPS spectrum result of the a-SnOOH nanoparticles and FIG. 12 showing the same result of the a-SnOOHNO nanoparticles, it can be seen that the VO peak intensity of the a-SnOOHNO nanoparticles produced by adding glycerol thereto significantly increased. Through the ESR spectrum of FIG. 8, it can be seen that the amount of VO is abundant in the a-SnOOHNO nanoparticles, and as can be seen in the FT-IR spectrum of FIG. 11, the a-SnOOHNO nanoparticles have a significant decrease in —OH and H—O—H peaks due to the influence of the VO.

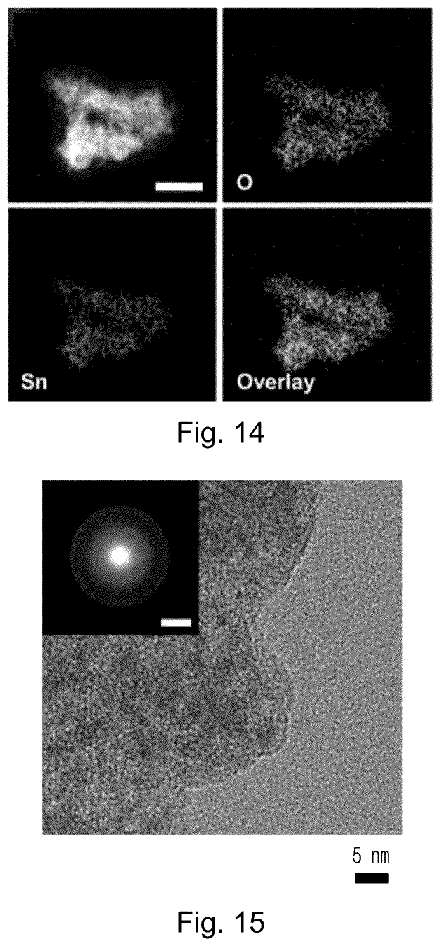

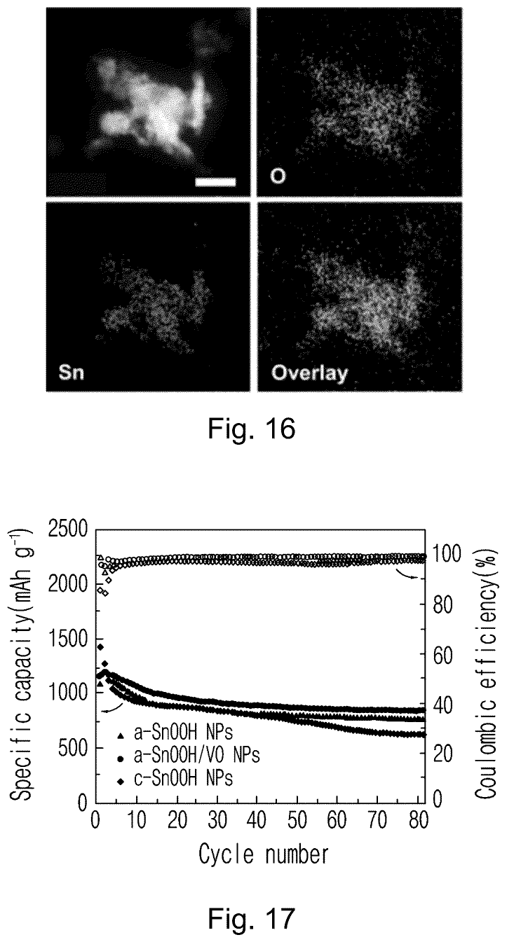

With respect to the a-SnOOH nanoparticles, FIG. 13 shows the HRTEM image and SAED pattern result thereof, and FIG. 14 shows the EDS mapping result thereof. In addition, with respect to the a-SnOOHNO nanoparticles, FIG. 15 shows the HRTEM image and SAED pattern result thereof, and FIG. 16 shows to the EDS mapping result thereof.

As a result of the EDS mapping, it was confirmed that the particles of Example 1-1, that is, the a-SnOOH NPs, had a Sn:O ratio of 1:3.81. In addition, it was confirmed that the particles of Example 1-2, that is, the a-SnOOHNO NPs, had a Sn:O ratio of 1:3.69, which is a state in which no more oxygen or OH groups are present compared to the particles of Example 1-1.

The BET surface area as a result of the BET surface measurement according to Experimental Example 8 is shown in Table 2 below.

TABLE 2

| | Particles | BET surface area (m²/g) |
|---|---|---|
| Example 1-1 | a-SnOOH NP | 59.77 |
| Example 1-2 | a-SnOOH/VO NP | 116.44 |

By enriching the amount of defects, that is, the amount of VO, the size and crystallinity of the SnOOHNO NPs were further reduced, thereby further increasing the BET surface area thereof, from which it was predicted that ion movement, that is, a charge transfer reaction, would be further facilitated from an electrochemical perspective.

The amount of defects, that is, the amount of VO, may be calculated through the ESR spectrum. FIG. 8 discloses the ESR spectra of Example 1-1, which is w/o glycerol, that is, a-SnOOH nanoparticles without defects, and Example 1-2, which is w/glycerol, that is, a-SnOOH/VO nanoparticles with defects. In FIG. 8, the intensity, which is the y-axis, represents a value obtained by differentiating absorbance with respect to the magnetic field, which is the x-axis. The absorbance refers to the distribution of the number of spins by magnetic field obtained through the ESR analysis in a material, and therefore, when the absorbance is integrated once more with respect to the x-axis, the total amount of defects in a particle and the spin density, which is the amount of spin, may be calculated.

The equation for the spin density Ns (spin/g) is as follows.

$${N}_{s} [ \frac{spin}{g} ] = \frac{Total number of spins}{Mass} = K \frac{\int ( Absorbance ) dB}{Mass} .$$

At this time, the constant of proportionality K may be derived by measuring a standard material, the spin density value of which is known, under the same conditions.

The spin density of Example 1-2 calculated thereby is shown in Table 3 below.

TABLE 3

| | Nanoparticles | Spin density Nₛ (spin/g) |
|---|---|---|
| Example 1-2 | a-SnOOH/VO | 2.86 × 10¹⁹ |

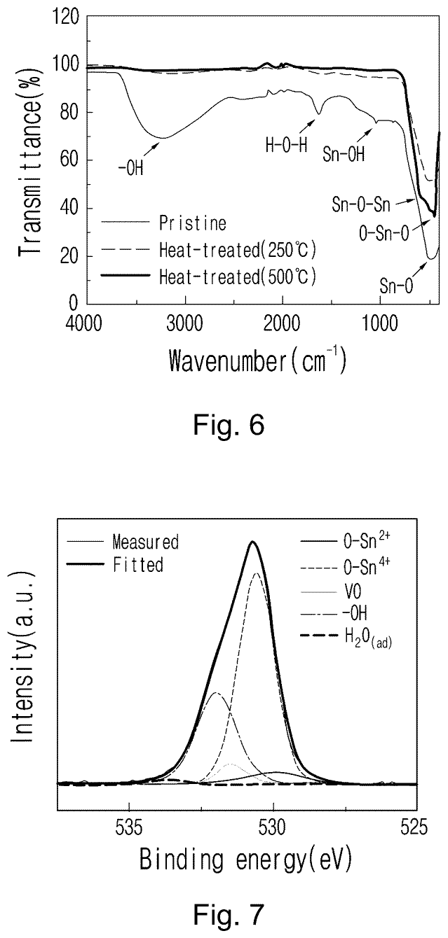

FIG. 6 shows the FT-IR spectrum results of the a-SnOOH particles obtained in Example 1-1 and particles obtained by subjecting the a-SnOOH particles to vacuum heat treatment at 250° C. and 500° C. and a dehydration reaction. As can be seen in FIG. 6, when the vacuum heat treatment is performed, the —OH group, and H—O—H and Sn—OH materials and the like are removed from the corresponding particles through the dehydration reaction, which provides that the particles according to Example 1-1 are a tin oxyhydroxide abundant in —OH bonds.

All of the cycle performance tests in the present application were performed at a current rate of 0.1 C only for the first cycle regardless of the indicated current rate thereof. This is to activate a reaction site.

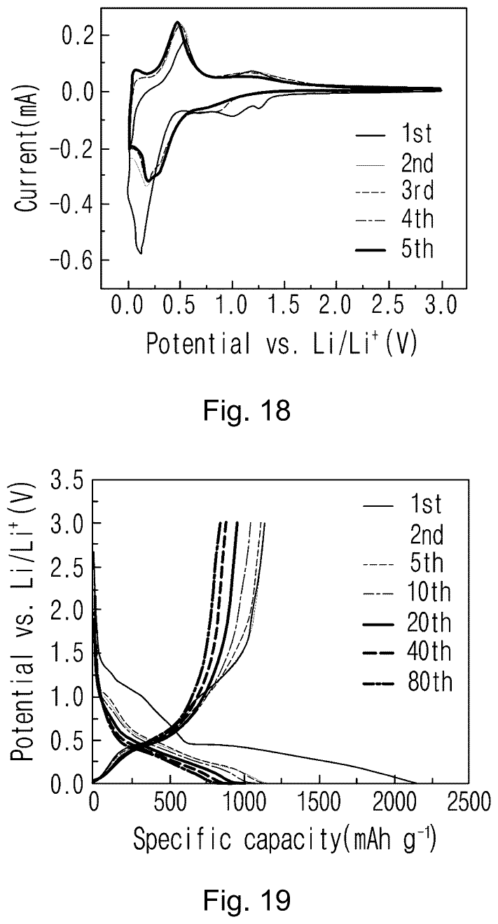

FIG. 18 shows a CV curve of the a-SnOOHNO nanoparticle negative electrode of Example 1-2 according to Experimental Example 11. It shows a charging and discharging process of a lithium ion battery, and it can be seen that the interval between oxidation and reduction peaks becomes narrow as the number of cycles increases. This indicates that as the number of cycles increases, the charging and discharging process stabilizes, thereby increasing ionic and electrical conductivity.

FIG. 19 shows charge/discharge potential curves of the a-SnOOHNO nanoparticle negative electrode of Example 1-2. The initial discharge capacity (initial capacity) is 2171.3 mAh/g, and the capacity decreases in the second cycle due to the solid electrolyte interface (SEI) thereof, but when comparing the capacity after the second cycle with the capacity after the 80-th cycle, it can be seen that there is no significant decrease.

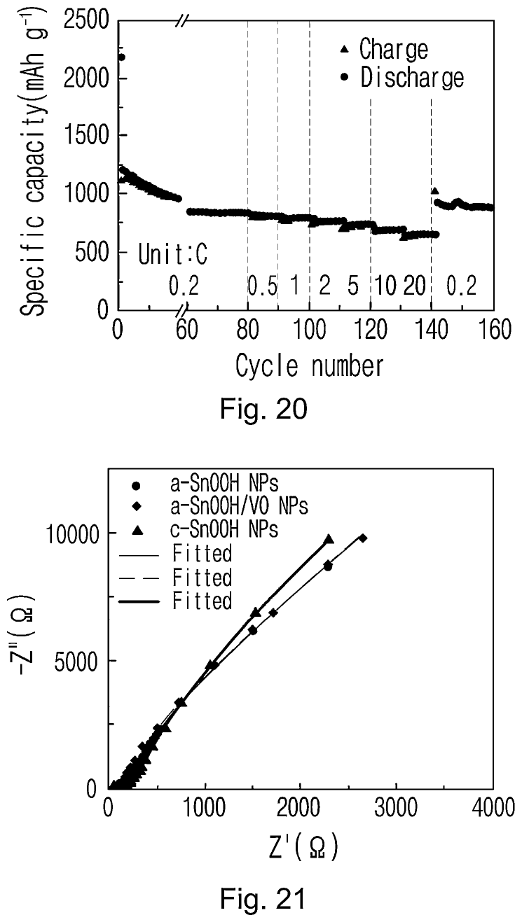

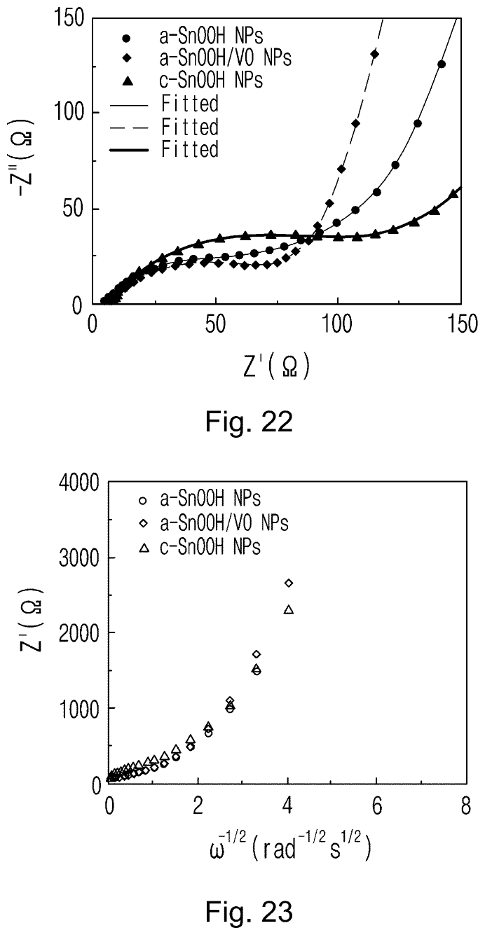

FIG. 20 shows rate properties of the a-SnOOHNO nanoparticle negative electrode. Similarly, only the first cycle was performed at 0.1 C, and the current rate of the remaining cycles was as follows, and the number of cycles and average discharge capacity for each current rate are as shown in Table 4 below.

TABLE 4

| Current | Number | Average discharge |
|---|---|---|
| rate (C) | of cycles | capacity (mAh/g) |
| 0.2 | 80 | 844.1 |
| 0.5 | 10 | 818.2 |
| 1 | 10 | 795.4 |
| 2 | 10 | 769.6 |
| 5 | 10 | 730.8 |
| 10 | 10 | 694.0 |
| 20 | 10 | 641.9 |
| 0.2 | 20 | 923.3 |

From the result of the test, it can be seen the battery manufactured using the a-SnOOHNO nanoparticles according to Example 1-2 showed a relatively high average discharge capacity despite the high current rate, which is due to a small change in volume between charging and discharging states thanks to the amorphous and defective form. In addition, it can be seen that after the 140-th cycle, an average discharge capacity similar to that of the initial cycle is recovered at a current rate of 0.2 C.

FIG. 17 shows the cycle performance results of negative electrodes of a-SnOOH nanoparticles, a-SnOOHNO nanoparticles, and c-SnOOH nanoparticles at a current rate of 0.2 C, and FIG. 32 shows the cycle performance results of negative electrodes of c-SnOOH nanoparticles and c-SnO₂ nanoparticles.

The cycle performance results presented in FIG. 17 and FIG. 32, that is, the initial discharge capacity (initial capacity), initial Coulombic efficiency, and discharge capacity values after the 80-th cycle in the discharge capacity and Coulomb efficiency graphs, are presented in Table 5.

TABLE 5

| | | Capacity | Initial | Average |
|---|---|---|---|---|
| | Initial | after | Coulombic | Coulombic |
| Negative | capacity | 80 cycles | efficiency | efficiency after |
| electrode | (mAh/g) | (mAh/g) | (%) | 1 cycle (%) |
| a-SnOOH NPs | 2234.1 | 757.9 | 47.4 | 98.1 |
| a-SnOOH/VO | 2171.3 | 841.2 | 51.1 | 98.7 |
| NPs | | | | |
| c-SnOOH NPs | 1937.6 | 622.2 | 62.2 | 96.3 |
| c-SnO₂ NPs | 2069.2 | 580.3 | 51.0 | 96.6 |

As can be seen in Table 5, there was no significant difference in the initial discharge capacity between the nanoparticles, but it can be seen that the a-SnOOH or a-SnOOHNO nanoparticles had better values than the c-SnOOH nanoparticles.

It can be seen that the discharge capacity of the SnOOH nanoparticles did not decrease even after several cycles compared to that of the SnO₂ nanoparticles, and that the capacity of the a-SnOOHNO nanoparticles did not decrease compared to that of the a-SnOOH nanoparticles, and the capacity of the a-SnOOH nanoparticles did not decrease compared to that of the c-SnOOH nanoparticles. This is due to the fact that the a-SnOOH nanoparticles have no grain boundary, and thus have a structure capable of accommodating a larger volume change during the inflow and outflow of lithium ions, and as a result, it can be seen that the a-SnOOH nanoparticles have higher cycle stability.

In the case of the initial Coulombic efficiency, it can be seen that there is no significant difference between the nanoparticles, but it can be seen that the a-SnOOHNO nanoparticles have a slightly better initial Coulombic efficiency than the a-SnOOH nanoparticles, which is due to the fact that even though the a-SnOOHNO nanoparticles have a smaller diameter than the a-SnOOH nanoparticles, the conductivity thereof is increased thanks to the presence of the vacancies (defects).

The average Coulombic efficiency after one cycle was higher in the order of a-SnOOHNO, a-SnOOH, and c-SnOOH, which is due to the fact that abundant defects in the a-SnOOHNO nanoparticles increased conductivity while providing more ion exchange sites.

Hereinafter, the EIS analysis and Nyquist plots performed in the present application will be described.

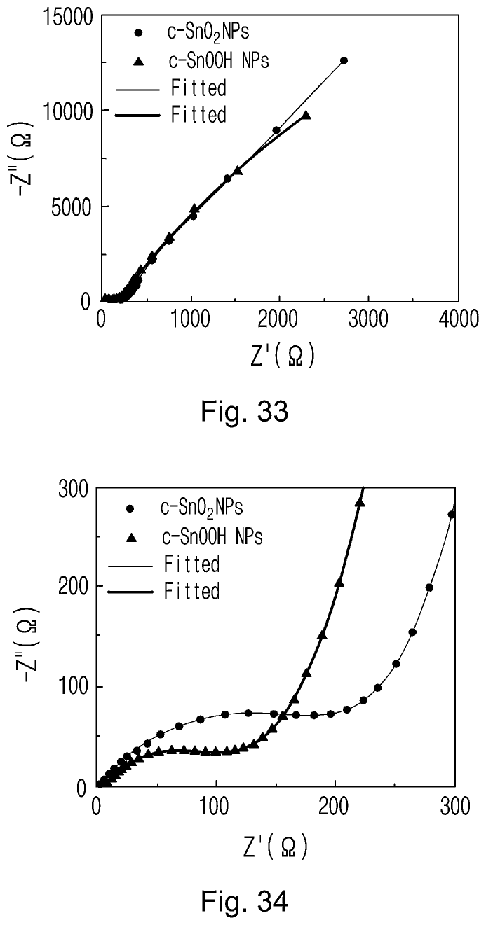

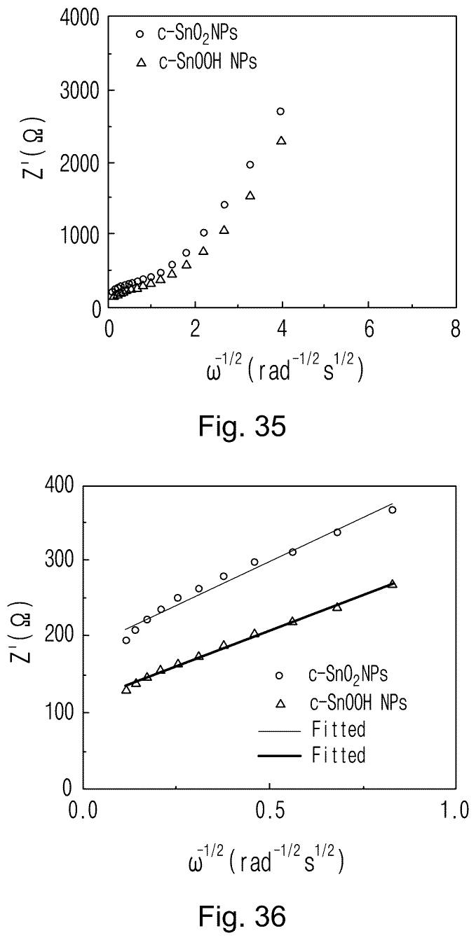

FIG. 21 and FIG. 33 show Nyquist plots of four types of particles after the first cycle was performed at a current rate of 0.1 C, and FIG. 23 and FIG. 35 respectively show the relationship between Z′ and ω^{-1/2} in the Nyquist plots of FIG. 21 and FIG. 33. Table 6 shows EIS parameter values calculated from the Nyquist curve fitting of negative electrodes of a-SnOOH nanoparticles, a-SnOOHNO nanoparticles, c-SnOOH nanoparticles, and c-SnO₂ nanoparticle after the first cycle at a current rate of 0.1 C.

$$ω ( \frac{rad}{s} ) = 2 \times π \times f ( f ) ( f is the frequency )$$

In order to calculate lithium ion diffusion properties in the negative electrodes, the relationship between Z′ and ω^{-1/2} in the EIS results was shown. In the graph, it can be seen that when ω^{-1/2} is less than 1, the graph takes the form of a straight line, but when ω^{-1/2} is greater than 1, the graph takes the form of a curve. The shape of the straight line corresponds to an ion diffusion process, and the shape of the curve corresponds to charge transfer finite diffusion.

The Warburg coefficient (a) is calculated by the following equation.

$${Z}^{′} = {R}_{s} + {R}_{SEI} + {R}_{ct} + σ \times {ω}^{- 1 / 2}$$

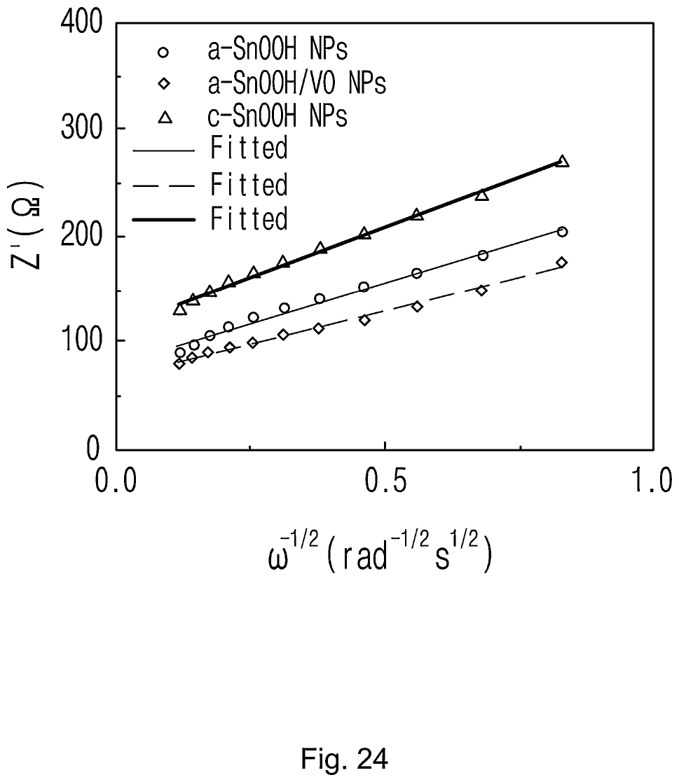

That is, the Warburg coefficient (a) may be obtained through the slope of a straight line when ω^{-1/2} is less than 1 in FIG. 24 and FIG. 36.

Through the Warburg coefficient (a), the Li ion diffusion coefficient value in each of negative electrode materials of the batteries manufactured in Examples 3-1 and 3-2 and Comparative Examples 3-1 and 3-2 may be calculated, and the equation is as follows.

$${D}_{L i +} = 0.5 {( RT / {An}^{2} {F}^{2} C σ )}^{2}$$

Here, R is the gas constant, A is the cross-sectional area of an electrode, n is the number of oxidized electrons per molecule, T is the measurement temperature, C is the molar concentration of Li ions, and F is the Faraday constant.

Each parameter value calculated through the EIS analysis is as shown in Table 6 below.

TABLE 6

| | Negative | R_{S} | R_{SEI} | R_{ct} | | |
|---|---|---|---|---|---|---|
| | electrode | (Ω) | (Ω) | (Ω) | σ(Ωrad^{1/2}s^{-1/2}) | D_{Li+}(cm²s⁻¹) |
| Example 3-1 | a-SnOOH | 5.1 | 15.1 | 92.9 | 151.6 | 7.20 × 10⁻¹⁶ |
| | NPs | | | | | |
| Example 3-2 | a-SnOOH/ | 6.0 | 14.4 | 72.3 | 123.5 | 1.09 × 10⁻¹⁵ |
| | VO NPs | | | | | |
| Comparative | c-SnOOH | 7.4 | 10.2 | 119.7 | 188.4 | 3.12 × 10⁻¹⁶ |
| Example 3-1 | NPs | | | | | |
| Comparative | c-SnO₂ | 3.1 | 19.5 | 224.2 | 230.6 | 2.33 × 10⁻¹⁶ |
| Example 3-2 | NPs | | | | | |

Rs (Ω) refers to electrolyte solution resistance (S resistance), R_{SEI} (Ω) refers to solid-electrolyte interface resistance (SEI resistance), and R_{ct} (Ω) refers to charge-transfer resistance (CT resistance).

The Rs (Ω) value is due to an electrolyte solution and a separator in a battery rather than properties of a negative electrode, and it can be seen that Examples 3-1 and 3-2 and Comparative Examples 3-1 and 3-2 all show a value of 3Ω to 7Ω.

In the case of the R_{SEI} (Ω) value, the lower the R_{SEI} (Ω) value, the higher the initial Coulombic efficiency, and the c-SnOOH nanoparticles have the lowest R_{SEI} (Ω) value, followed by the a-SnOOHNO nanoparticles, the a-SnOOH nanoparticles, and the c-SnO₂ nanoparticles. This is also related to the order of the initial Coulombic efficiency described above, and it is interpreted to be due to the fact that even though the a-SnOOHNO nanoparticles have a smaller diameter than the a-SnOOH nanoparticles, the conductivity thereof is increased thanks to the presence of the vacancies (defects).

In the case of Ret (Ω), it can be seen that the lower the value, the better the electrical conductivity, and it can be seen that the SnOOH nanoparticles have much better electrical conductivity than the SnO₂ nanoparticles, and that the electrical conductivity increases in the order of c-SnOOH nanoparticles, a-SnOOH nanoparticles, and a-SnOOHNO nanoparticles. This shows that an amorphous form and a defective form play a positive role in electrical conductivity.

It can be seen that the larger the D_{Li+}(cm²s⁻¹) value, the higher the cycle properties and rate properties. As a result of the calculation, it can be seen that tin oxyhydroxide nanoparticles have a higher value than tin oxide nanoparticles, that a-SnOOH nanoparticles have a higher value than c-SnOOH nanoparticles, and that a-SnOOHNO nanoparticles have a higher value than a-SnOOH nanoparticles. It can be seen that the reason for the high diffusion properties of lithium ions is also due to the influence of the amorphous form and the defective form on the high cycle properties and the rate properties.

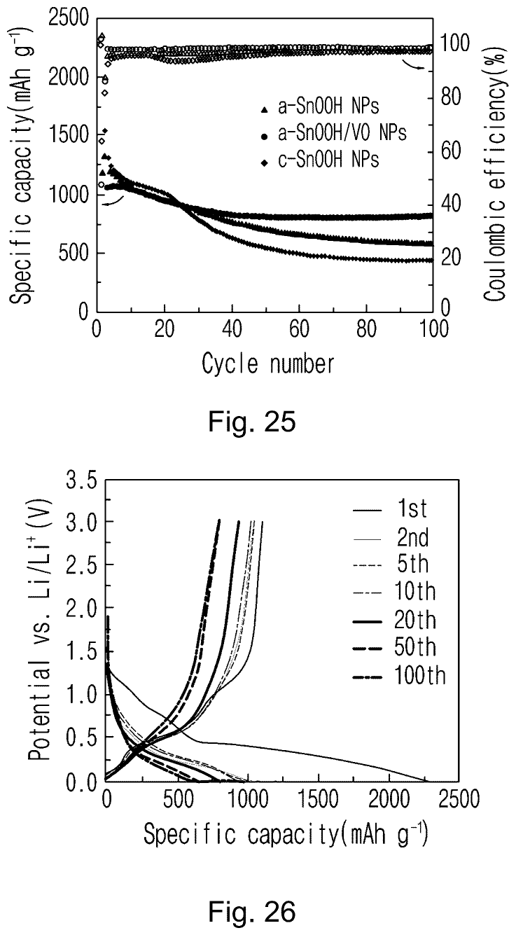

FIG. 25 shows the cycle performance of batteries at a current rate of 2 C, which are equipped with negative electrodes of a-SnOOH nanoparticles, a-SnOOHNO nanoparticles, and c-SnOOH nanoparticles respectively corresponding to Examples 3-1 and 3-2, and Comparative Example 3-1.

As can be seen in FIG. 25, the a-SnOOHNO nanoparticle negative electrode battery, which is Example 3-2, shows a greater capacity than other batteries after 100 cycles, and has an average Coulombic efficiency after one cycle of 99%. This shows that the a-SnOOHNO nanoparticle negative electrode battery has the advantage at a fast charge/discharge rate.

FIG. 26 shows charge/discharge potential curves of Example 3-2 at a current rate of 2 C, and as with the current rate of 0.2 C in FIG. 19, there is a slight decrease in capacity between the initial capacity and the capacity after the second cycle, but when comparing the capacity after the first cycle and the capacity after the 100-th cycle, it can be seen that there is no significant decrease.

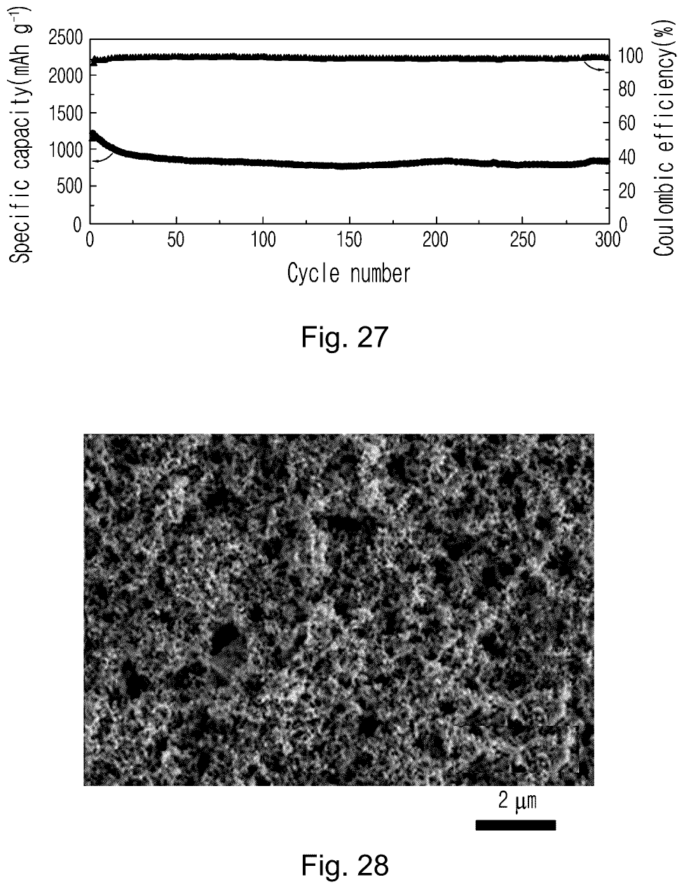

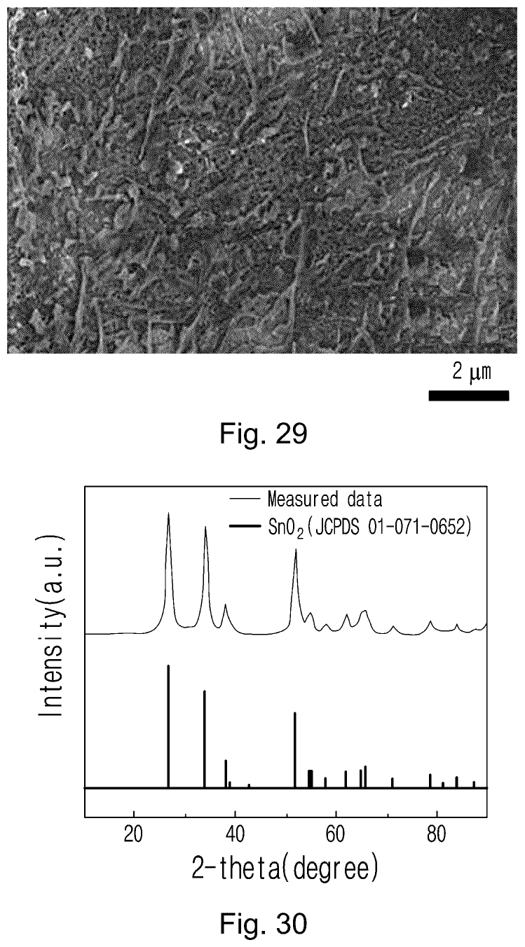

FIG. 27 shows long-term cycle performance of the a-SnOOHNO nanoparticle negative electrode battery, which is Example 3-2, at a current rate of 0.2 C, and it can be seen from the test result that despite 300 cycles of charging and discharging, the capacity thereof is 853.3 mAh/g, and the Coulombic efficiency thereof is 98.4%. This indicates the long-term sustainability of the battery of Example 3-2 of the present application. In addition, as can be seen in FIG. 28 and FIG. 29, when comparing FESEM images before and after the 300 cycle test, it was confirmed that the surface of the negative electrode was not significantly destroyed.

A metal oxyhydroxide nanoparticle according to the present invention has a unique structure, thereby having a small change in volume when lithium ions are inserted thereinto, and thus, may become a key negative electrode active material in the production of a negative electrode material. In addition, the metal oxyhydroxide nanoparticle according to the present invention lacks a crystalline structure due to the amorphous form thereof or due to the presence of oxygen vacancy (VO), which is referred to as a defect, and thus, when used as a negative electrode material, has a small change in volume during charging and discharging, thereby having excellent ionic and electrical conductivity, battery capacity, and cycle life.

Having now fully described the present invention in some detail byway of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

What is claimed is:

1. An amorphous metal oxyhydroxide represented by Chemical Formula 1 below:
MₓO_{y}(OH)_{z} [Chemical Formula 1]
wherein, in [Chemical Formula 1] above, M is one or more selected from the group consisting of tin, aluminum, titanium, vanadium, chromium, manganese, iron, cobalt, nickel, gallium, zirconium, niobium, molybdenum, indium, and tantalum, and 0.4≤x≤0.7, 0.1≤y≤0.4, 1.6≤z≤1.9, y+z=2, and −0.154x-2y-z≤0.1.

2. The amorphous metal oxyhydroxide of claim 1, wherein 0.5≤x≤0.6.

3. The amorphous metal oxyhydroxide of claim 1, wherein 0.2≤y≤0.3.

4. The amorphous metal oxyhydroxide of claim 1, wherein 1.7≤z≤1.8.

5. A negative electrode active material for a secondary battery comprising the metal oxyhydroxide according to claim 1.

6. A negative electrode material for a secondary battery comprising the metal oxyhydroxide according to claim 1.

7. A secondary battery comprising the metal oxyhydroxide according to claim 1.

8. A method for producing an amorphous metal oxyhydroxide, the method comprising the step of obtaining the amorphous metal oxyhydroxide according to claim 1 through an anodization process through a 2-electrode electrochemical system which includes:
a working electrode including one or more selected from the group consisting of tin, aluminum, titanium, vanadium, chromium, manganese, iron, cobalt, nickel, gallium, zirconium, niobium, molybdenum, indium, and tantalum;
a counter electrode; and
an electrolyte containing a potassium halide aqueous solution.

9. The method of claim 8, wherein the potassium halide aqueous solution is a KI aqueous solution.

10. The method of claim 8, wherein the electrolyte additionally comprises glycerol.

11. The method of claim 1, wherein the spin density of the amorphous metal oxyhydroxide is 1.00×¹⁰10 or greater.
